(19) United States
(12) Patent Application Publication
(10) Pub. No.: US 2024/0302502 A1
(43) Pub. Date: Sep. 12, 2024

(54) SUBFRAMES AND PHASE SHIFTING FOR LIDAR ACQUISITION

(71) Applicant: Ouster, Inc., San Francisco, CA (US)

(72) Inventor: Richmond G. Hollen, San Francisco, CA (US)

(73) Assignee: Ouster, Inc., San Francisco, CA (US)

(21) Appl. No.: 18/600,612

(22) Filed: Mar. 8, 2024

Related U.S. Application Data
(60) Provisional application No. 63/451,210, filed on Mar. 9, 2023.

(51) Int. Cl. G01S 7/481; G01S 7/4865; G01S 17/58; G01S 17/894

(52) U.S. Cl. CPC G01S 7/4816; G01S 7/4865; G01S 17/58; G01S 17/894

(57) ABSTRACT

Systems, methods, and apparatus that can spread peak power dissipation (such as emitter power) in a lidar system over an increased range of time. Spreading the emitter power over time can provide several advantages. Dispersing the power supply noise and current spikes can reduce the load or stress on power supply components such as power transistors, decoupling capacitors, and others. Power supply noise and voltage drops can be reduced by allowing power supply decoupling capacitors time to recover between bursts of pulses. This can allow the use of lower-power transistors, smaller capacitors, and other changes that can conserve resources. Component heating, for example in the emitter array, can be reduced by providing time between bursts of pulses for device cooling. Lidar system performance can be improved since power supplies, bias lines, device temperatures, and other parameters have time to recover between the multiple smaller bursts of pulses, or subframes, as compared to a longer, single burst of pulses. Examples can utilize multiple subframes instead of a single frame. Using multiple subframes instead of a single frame can provide further advantages. Since histogram data can be moved out of the pixel circuits for each subframe, a reduced amount of memory can be needed in each pixel, thereby simplifying pixel circuitry. Further, by phase shifting subframe histogram data before combining, timing resolution of the combined histogram data can be increased. The linear regression, linear interpolation, or other method used to align the subframe data can provide a relative radial velocity between the lidar system and an object being imaged by the pixel.

### CROSS-REFERENCES TO RELATED APPLICATIONS

This application claims priority to and the benefit of U.S. provisional patent application No. 63/451,210, filed Mar. 9, 2023, which is incorporated by reference.

### BACKGROUND

This disclosure relates generally to lidar systems and more specifically increasing the dynamic range of lidar systems.

Time-of-flight (ToF) based imaging is used in a number of applications, including range finding, depth profiling, and 3D imaging, for example light imaging, detection, and ranging (LiDAR, or lidar). Direct time-of-flight (dToF) measurement includes directly measuring the length of time between emitting radiation from emitter elements and sensing the radiation by sensor elements after reflection from an object or other target. The distance to the target can be determined from the measured length of time. Indirect time-of-flight measurement includes determining the distance to the target by phase modulating the amplitude of the signals emitted by the emitter elements of the lidar system and measuring phases (e.g., with respect to delay or shift) of the echo signals received at the sensor elements of the lidar system. These phases can be measured with a series of separate measurements or samples.

In specific applications, the sensing of the reflected radiation in either direct or indirect time-of-flight systems can be performed using an array of detectors, for example an array of Single-Photon Avalanche Diodes (SPADs). One or more detectors can define a sensor for a pixel, where a sensor array can be used to generate a lidar image for the depth (range) to objects for respective pixels.

When imaging a scene, these sensors, which can also be referred to as ToF sensors or photosensors, can include circuits that time-stamp and count incident photons as reflected from a target. Data rates can be compressed by histogramming timestamps. For instance, for each pixel, a histogram having bins (also referred to as “time bins”) corresponding to different ranges of photon arrival times can be stored in memory, and photon counts can be accumulated in different time bins of the histogram according to their arrival time. A time bin can correspond to a duration of, e.g., 1 ns, 2 ns, or the like. Some lidar systems can perform in-pixel histogramming of incoming photons using a clock-driven architecture and a limited memory block, which can provide a significant increase in histogramming capacity. However, since memory capacity is limited and typically cannot cover the desired distance range at once, such lidar systems can operate in “strobing” mode. “Strobing” refers to the generation of detector control signals (also referred to herein as “strobe signals” or “strobes”) to control the timing and/or duration of activation (also referred to herein as “detection windows” or “strobe windows”) of one or more detectors of the lidar system, such that photon detection and histogramming is performed sequentially over a set of different time windows, each corresponding to an individual distance subrange, so as to collectively define the entire distance range. In other words, partial histograms can be acquired for subranges or “time slices” corresponding to different sub-ranges of the distance range and then amalgamated into one full-range histogram. Thousands of time bins (each corresponding to respective photon arrival times) can typically be used to form a histogram sufficient to cover the typical time range of a lidar system (e.g., microseconds) with the typical time-to-digital converter (TDC) resolution (e.g., 50 to 100 picoseconds).

Reflected light from the emitter elements can be received using a sensor array. The sensor array can be an array of SPADs for an array of pixels, also referred to as channels, where each pixel includes one or more SPADs to form one or more detector components. These SPADs can work in conjunction with other circuits, for example address generators, accumulation logic, memory circuits, and the like, to generate a lidar image.

A lidar system can capture images by sending light or other signals in the form of pulses using an emitter array. Following each pulse, data at an array of SPADs can be captured. This data can be processed and from the processed data an image can be generated. Much of the power using during this procedure can be consumed by the emitter array. Unfortunately, this means that much of the power used in generating an image can occur during a short interval. Such a burst of power consumption can tax power supply circuits, cause local heating, and degrade performance.

Thus, what is needed are systems, methods, and apparatus that can temporally distribute power consumption of a lidar system more evenly throughout an image capture process.

### SUMMARY

Accordingly, embodiments of the present invention can provide systems, methods, and apparatus that can temporally distribute power consumption of a lidar system more evenly throughout an image capture process. An illustrative embodiment of the present invention can distribute a number of light pulses emitted by an emitter array throughout the image capture process. For example, X/N pulses, where N is an integer and X is a total number of pulses used to generate a pixel of an image, can be emitted for each of N subframes, where the N subframes are temporally spaced. For each subframe, SPAD data can be accumulated as a histogram in pixel memory following each pulse. The process of emitting X/N pulses and accumulating corresponding SPAD data can be referred to as a subframe, where N subframes are used to form a frame for a pixel for an image.

By emitting a number N shorter bursts instead of a single longer burst, power drawn by the emitter can be spread out over time. This is in comparison to conventional systems, where a number X of light pulses are emitted and SPAD data is accumulated into a single histogram before being transferred from a pixel.

Spreading the emitter power over time can provide several advantages. Dispersing the power supply noise and current spikes can reduce the load or stress on power supply components such as power transistors, decoupling capacitors, and others. Power supply noise and voltage drops can be reduced by allowing power supply decoupling capacitors time to recover between bursts of pulses. This can allow the use of lower-power transistors, smaller capacitors, and other changes that can conserve resources. Component heating, for example in the emitter array, can be reduced by providing time between bursts of pulses for device cooling. Lidar system performance can be improved since power supplies, bias lines, device temperatures, and other parameters have time to recover between the multiple smaller bursts of pulses, or subframes, as compared to a longer, single burst of pulses.

Histogram data for a subframe can be transferred from pixel memory to a digital-signal processor or other circuit following the X/N light pulses for further processing, or the histogram data can be processed in the pixel before being transferred from pixel memory. That is, data can be transferred from pixel memory for each subframe, either before or after processing in the pixel. Histogram data for the N number of subframes can then be combined into a single histogram. This can be done by circuitry for a pixel, by digital-signal processing circuits, or by other circuits, which can reduce an amount of data to be transferred out of the pixel to other circuits. However, since histogram data for the subframes are taken over a period, the motion of the lidar system, the motion of the object being imaged by the pixel, or both, can act to smear or distort the combined results, resulting in a lower overall signal-to-noise ratio.

Accordingly, embodiments of the present invention can compensate for the relative motion that occurs among the N subframes. For example, a peak can be detected in the histogram data for each of the subframes. The peaks can be in different positions in each histogram as a result of the relative motion between the lidar system and the object being imaged. Linear regression, linear interpolation, line-fitting, or other technique can be performed and the results used to determine the change in position for a peak among the subframes. The change in the position of a peak can be used to estimate the relative motion that occurred during the N subframes. The resulting estimate can be used to assemble, add, or combine the N subframes. That is, the motion estimated by interpolation can be used to generate an expected change in relative position in the histogram bins, which can be used to reposition the histograms of the subframes to compensate for this relative motion. The results of the motion estimation can also be used to estimate radial velocity between the lidar system and an object being imaged by the pixel and this estimate can be provided to other circuits in or associated with the lidar system.

The N subframes for each pixel can be combined or added in various ways. For example, the peaks in each subframe histogram can be aligned with each other and the N subframe histograms can be added together. Alternatively, the peaks can be offset from one another by a phase shift. The phase shift can be equal to a duration of a bin divided by N. In terms of degrees, the phase shift can be 360/N degrees. For example, where N is equal to 4, the phase shift can be 90 degrees. By phase shifting the subframes in this way, the timing resolution of the combined subframes can be increased by a factor of N, thereby improving image data. Also, instead of increasing resolution, bin size for the subframe histograms can be increased by a factor of N, thereby reducing memory requirements in the pixels. Alternatively, a combination of improving timing resolution and increasing bin size can be employed. For example, where N is equal to four, both the timing resolution and the bin size can be increased by a factor of two. Also, the bit resolution of histogram data can be decreased.

Using multiple subframes instead of a single frame can provide various advantages. As described, multiple subframes can disperse power supply noise and glitching over a longer period as compared to sending emitted pulses and accumulating SPAD data as a single frame. Also, since histogram data can be moved out of the pixel circuits for each subframe, a reduced amount of memory can be needed in each pixel, thereby simplifying pixel circuitry. Further, by phase shifting subframe histogram data before combining, timing resolution of the combined histogram data can be increased by a factor of N. The linear regression, linear interpolation, line-fitting, or other method used to align the subframe data can provide a relative radial velocity between the lidar system and an object being imaged by the pixel.

The emitter power for each subframe can be held constant among the subframes of a frame. In these and other embodiments of the present invention, the power for one or more subframes can be increased or decreased relative to other subframes. For example, when a peak detected in one or more subframes is at a saturation level due to a high flux or high reflectivity object, the emitter power for one or more following subframes can be reduced to improve peak detection. When a peak detected in one or more subframes is near a background noise level, the emitter power for one or more following subframes can be increased to improve peak detection. Instead of being dynamically adjusted based on earlier subframes in a frame, the variation in emitter power among subframes can be predetermined by a program, by results of earlier frames, or in other ways.

The number of peaks detected in each subframe can vary. For example, for each pixel, a single peak can be detected in each subframe. Alternatively, a number of peaks can be found for some or all of the subframes in a frame. For example, an integral number of peaks can be found. A binary number of peaks can be found, such as two, four, or eight. Other numbers of peaks, such as three, five, or six peaks can be found in each subframe. Memory usage can be reduced by only storing histogram data around the detected peaks. The memory usage reduction can occur in a pixel or in another processing circuit in the lidar system.

In these and other embodiments of the present invention, a frame can be temporally divided into two or more subframes. In these and other embodiments of the present invention, a frame can be divided into two or more subframes based on distance. For example, one or more subframes capturing data over a first range of distance can be run, while one or more further subframes capturing data over a second range of distance can subsequently be run, where the first range and the second range are different. The first range and the second range can be adjacent, they can overlap, they can be separate, or they can have other relationships. Three, four, or more than four ranges can be used, and they can be varied to run different in different sequences.

One or more other techniques can be incorporated into embodiments of the present invention. For example, emitter firing delays in one or more subframes can be dithered to improve resolution. The value of N can have different values. N can be an integer. N can be a binary based number, such as two, four, or eight. N can have another value, such as three, five, or six.

Some embodiments described herein provide methods, systems, and devices including electronic circuits that provide a lidar system including one or more emitter elements (including one or more light emitting devices or lasers, for example surface-or edge-emitting laser diodes; generally referred to herein as emitters or emitter elements) that output optical signals (referred to herein as emitter signals) in response to emitter control signals, one or more detector elements or sensor elements (including photodetectors, for example photodiodes, including avalanche photodiodes and single-photon avalanche detectors; generally referred to herein as detectors) that output detection signals in response to incident light (also referred to as detection events), and/or one or more control circuits that are configured to operate a non-transitory memory device to store data indicating the detection events in different subsets of memory banks during respective subframes of an imaging frame, where the respective subframes include data collected over multiple cycles or pulse repetitions of the emitter signals. For example, the one or more control circuits may be configured to operate the emitter and detector elements to collect data over fewer pulse repetitions of the emitter signal with smaller memory utilization (e.g., fewer memory banks) when imaging closer distance subranges, and to collect data over more pulse repetitions of the emitter signal with larger memory utilization (e.g., more memory banks) when imaging farther distance subranges.

In some embodiments, the control circuit(s) include a timing circuit that is configured to direct photon counts to a first subset of the memory banks based on their times-of-arrival with respect to the timing of the emitter signal during a first subframe, and to a second subset of the memory banks based on their times-of-arrival with respect to the timing of the emitter signal during a second subframe, thereby varying the number of memory banks and/or the time bin allocation of each memory bank or storage location for respective subframes of the imaging frame.

According to some embodiments of the present invention, a lidar detector circuit includes a plurality of detector pixels, with each detector pixel of the plurality comprising one or more detector elements; a non-transitory memory device comprising respective memory storage locations or memory banks configured to store photon count data for respective time bins or photon times-of arrival; and at least one control circuit configured to vary or change the number of memory banks and/or the allocation of respective time bins to the respective memory banks responsive to a number of pulse repetitions of an emitter signal. The at least one control circuit may be configured to change the respective time bins allocated to the respective banks from one subframe to the next by altering the timing of respective memory bank enable signals relative to the time between pulses of the emitter signal for the respective subframes. In some embodiments, the time bins of the respective subframes may have a same duration or bin width.

Various detector components formed of one or more SPADs can be implemented in these and other embodiments of the present invention. These detector components can be formed as arrays of individual SPADs, where the individual SPADs are connected together in different numbers to provide a number of detector components having different sensitivities.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 is a simplified block diagram of a lidar system according to some embodiments;

FIG. 2 is a simplified block diagram of components of a time-of-flight measurement system or circuit according to some embodiments;

FIG. 3 illustrates the operation of a typical lidar system that can be improved by embodiments;

FIG. 4 shows a histogram according to embodiments of the present invention;

FIG. 5 shows the accumulation of a histogram over multiple pulse trains for a selected pixel according to embodiments of the present invention;

FIG. 6 illustrates an example of a pixel according to an embodiment of the present invention;

FIG. 7 illustrates a method of generating a histogram in a lidar system according to an embodiment of the present invention;

FIG. 8A and FIG. 8B illustrates timing for generating image data according to an embodiment of the present invention;

FIG. 9 illustrates a method of phase shifting subframes according to an embodiment of the present invention;

FIG. 10A and FIG. 10B illustrate improvements that can be gained by phase shifting subframes according to an embodiment of the present invention;

FIG. 11 illustrates phase shifting subframes according to an embodiment of the present invention;

FIG. 12 illustrates a method of improving the dynamic range of a lidar system according to an embodiment of the present invention;

FIG. 13 illustrates a method of compensating for motion during the generation of histogram data according to an embodiment of the present invention;

FIG. 14A and FIG. 14B are flowcharts illustrating methods of generating image data according to an embodiment of the present invention; and

FIG. 15 is a simplified illustration of an automobile in which four solid-state flash lidar sensors are included at different locations along the automobile.

### DETAILED DESCRIPTION

Embodiments of the present invention can spread peak power dissipation (most likely emitter power) in a lidar system over an increased range of time. Spreading the emitter power over time can provide several advantages. Dispersing the power supply noise and current spikes can reduce the load or stress on power supply components such as power transistors, decoupling capacitors, and others. Power supply noise and voltage drops can be reduced by allowing power supply decoupling capacitors time to recover between bursts of pulses. This can allow the use of lower-power transistors, smaller capacitors, and other changes that can conserve resources. Component heating, for example in the emitter array, can be reduced by providing time between bursts of pulses for device cooling. Lidar system performance can be improved since power supplies, bias lines, device temperatures, and other parameters have time to recover between the multiple smaller bursts of pulses, or subframes, as compared to a longer, single burst of pulses.

Embodiments of the present invention can utilize multiple subframes instead of a single frame. Using multiple subframes instead of a single frame can provide various advantages. As described, multiple subframes can disperse power supply noise and glitching over a longer period as compared to sending emitted pulses and accumulating SPAD data as a single frame. Also, since histogram data can be moved out of the pixel circuits for each subframe, a reduced amount of memory can be needed in each pixel, thereby simplifying pixel circuitry. Further, by phase shifting subframe histogram data before combining, resolution of the combined histogram data can be increased by a factor of N. The linear regression, linear interpolation, or other method used to align the subframe data can provide a relative radial velocity between the lidar system and an object being imaged by the pixel.

### 1. Example Lidar System

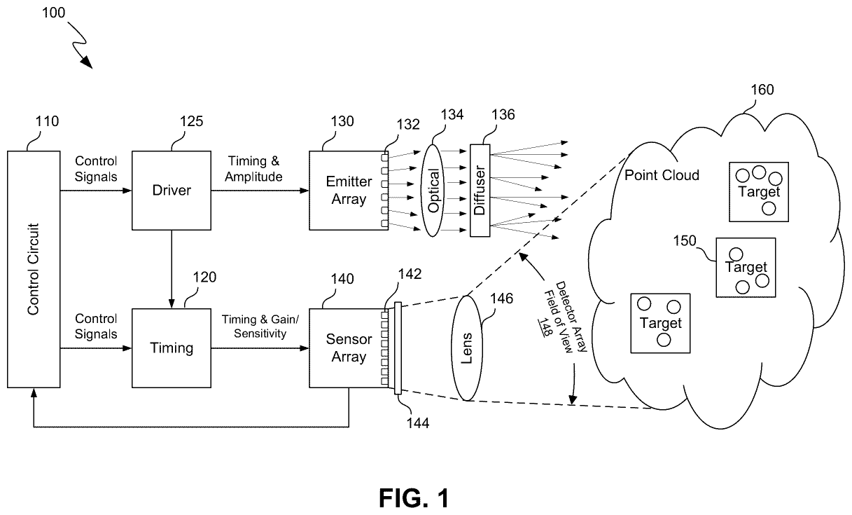

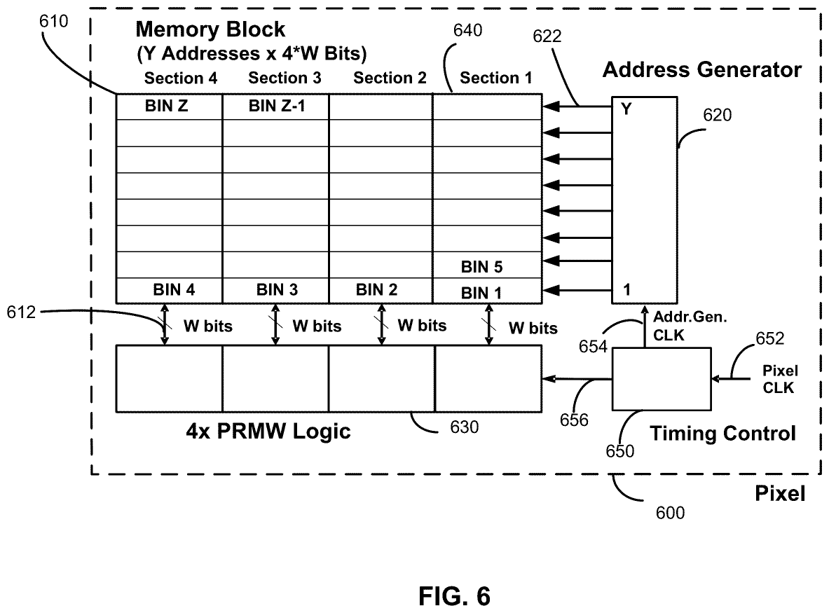

FIG. 1 illustrates an example light-based 3D sensor system 100, for example a Light Detection and Ranging (LiDAR, or lidar) system, in accordance with some embodiments of the invention. Lidar system 100 can include a control circuit 110, a timing circuit 120, driver circuitry 125, an emitter array 130 and a sensor array 140. Emitter array 130 can include a plurality of emitter units (or emitter elements) 132 arranged in an array (e.g., a one- or two-dimensional array) and sensor array 140 can include a plurality of sensors or sensor elements 142 arranged in an array (e.g., a one-or two-dimensional array). The sensors 142 can be depth sensors, for example time-of-flight (ToF) sensors. In some embodiments each sensor 142 can include, for example, one or more single-photon detectors, for example Single-Photon Avalanche Diodes (SPADs). In some embodiments, each sensor 142 can be coupled to an in-pixel memory block 610 (shown in FIG. 6) that accumulates histogram data for that sensor 142, and the combination of a sensor and in-pixel memory circuitry is sometimes referred to as a “pixel” 142. Each emitter unit 132 of the emitter array 130 can include one or more emitter elements that can emit a radiation pulse (e.g., light pulse) or continuous wave signal at a time and frequency controlled by a timing generator or driver circuitry 125. In some embodiments, the emitter units 132 can be pulsed light sources, for example LEDs or lasers including vertical cavity surface emitting lasers (VCSELs) that emit a cone of light (e.g., infrared light) having a predetermined beam divergence.

Emitter array 130 can project pulses of radiation into a field of view of the lidar system 100. Some of the emitted radiation can then be reflected back from objects in the field, for example targets 150. The radiation that is reflected back can then be sensed or detected by the sensors 142 within the sensor array 140. Control circuit 110 can implement a processor that measures and/or calculates the distance to targets 150 based on data (e.g., histogram data) provided by sensors 142. In some embodiments control circuit 110 can measure and/or calculate the time of flight of the radiation pulses over the journey from emitter array 130 to target 150 and back to the sensors 142 within the sensor array 140 using direct or indirect time-of-flight (ToF) measurement techniques.

In some embodiments, emitter array 130 can include an array (e.g., a one-or two-dimensional array) of emitter units 132 where each emitter unit is a unique semiconductor chip having one or more individual VCSELs (sometimes referred to herein as emitter elements) formed on the chip. An optical element 134 and a diffuser 136 can be disposed in front of the emitter units such that light projected by the emitter units passes through the optical element 134 (which can include, e.g., one or more Fresnel lenses) and then through diffuser 136 prior to exiting lidar system 100. In some embodiments, optical element 134 can be an array of lenses or lenslets (in which case the optical element 134 is sometimes referred to herein as “lens array 134” or “lenslet array 134”) that collimate or reduce the angle of divergence of light received at the array and pass the altered light to diffuser 136. The diffuser 136 can be designed to spread light received at the diffuser over an area in the field that can be referred to as the field of view of the emitter array (or the field of illumination of the emitter array). In general, in these embodiments, emitter array 130, lens array or optical element 134, and diffuser 136 cooperate to spread light from emitter array 130 across the entire field of view of the emitter array. A variety of emitters and optical components can be used.

The driver circuitry 125 can include one or more driver circuits, each of which controls one or more emitter units. The driver circuits can be operated responsive to timing control signals with reference to a master clock and/or power control signals that control the peak power and/or the repetition rate of the light output by the emitter units 132. In some embodiments, each of the emitter units 132 in the emitter array 130 is connected to and controlled by a separate circuit in driver circuitry 125. In other embodiments, a group of emitter units 132 in the emitter array 130 (e.g., emitter units 132 in spatial proximity to each other or in a common column of the emitter array), can be connected to a same circuit within driver circuitry 125. Driver circuitry 125 can include one or more driver transistors configured to control the modulation frequency, timing, and/or amplitude of the light (optical emission signals) output from the emitter units 132.

In some embodiments, a single event of emitting light from the multiple emitter units 132 can illuminate an entire image frame (or field of view); this is sometimes referred to as a “flash” lidar system. Other embodiments can include non-flash or scanning lidar systems, in which different emitter units 132 emit light pulses at different times, e.g., into different portions of the field of view. The maximum optical power output of the emitter units 132 can be selected to generate a signal-to-noise ratio of the echo signal from the farthest, least reflective target at the brightest background illumination conditions that can be detected in accordance with embodiments described herein. In some embodiments, an optical filter (not shown) for example a bandpass filter can be included in the optical path of the emitter units 132 to control the emitted wavelengths of light.

Light output from the emitter units 132 can impinge on and be reflected back to lidar system 100 by one or more targets 150 in the field. The reflected light can be detected as an optical signal (also referred to herein as a return signal, echo signal, or echo) by one or more of the sensors 142 (e.g., after being collected by receiver optics 146), converted into an electrical signal representation (sometimes referred to herein as a detection signal), and processed (e.g., based on time-of-flight techniques) to define a 3-D point cloud representation 160 of a field of view 148 of the sensor array 140. In some embodiments, operations of lidar systems can be performed by one or more processors or controllers, for example control circuit 110.

Sensor array 140 includes an array of sensors 142. In some embodiments, each sensor 142 can include one or more photodetectors, e.g., SPADs. And in some particular embodiments, sensor array 140 can be a very large array made up of hundreds of thousands or even millions of densely packed SPADs. Receiver optics 146 and receiver electronics (including timing circuit 120) can be coupled to the sensor array 140 to power, enable, and disable all or parts of the sensor array 140 and to provide timing signals thereto. In some embodiments, sensors 142 can be activated or deactivated with at least nanosecond precision (supporting time bins of 1 ns, 2 ns, etc.), and in various embodiments, sensors 142 can be individually addressable, addressable by group, and/or globally addressable. The receiver optics 146 can include a bulk optic lens that is configured to collect light from the largest field of view that can be imaged by the lidar system 100, which in some embodiments is determined by the aspect ratio of the sensor array 140 combined with the focal length of the receiver optics 146.

In some embodiments, the receiver optics 146 can further include various lenses (not shown) to improve the collection efficiency of the sensors and/or an anti-reflective coating (also not shown) to reduce or prevent detection of stray light. In some embodiments, a spectral filter 144 can be positioned in front of the sensor array 140 to pass or allow passage of “signal” light (i.e., light of wavelengths corresponding to wavelengths of the light emitted from the emitter units) but substantially reject or prevent passage of non-signal light (i.e., light of wavelengths different from the wavelengths of the light emitted from the emitter units).

The sensors 142 of sensor array 140 are connected to the timing circuit 120. The timing circuit 120 can be phase-locked to the driver circuitry 125 of emitter array 130. The sensitivity of each of the sensors 142 or of groups of sensors 142 can be controlled. For example, when the sensors 142 include reverse-biased photodiodes, avalanche photodiodes (APD), PIN diodes, and/or Geiger-mode avalanche diodes (e.g., SPADs), the reverse bias can be adjusted. In some embodiments, a higher overbias provides higher sensitivity.

In some embodiments, control circuit 110, which can be, for example, a microcontroller or microprocessor, provides different emitter control signals to the driver circuitry 125 of different emitter units 132 and/or provides different signals (e.g., strobe signals) to the timing circuit 120 of different sensors 142 to enable/disable the different sensors 142 to detect the echo signal (or returning light) from the target 150. The control circuit 110 can also control memory storage operations for storing data indicated by the detection signals in a non-transitory memory or memory array that is included therein or is distinct therefrom.

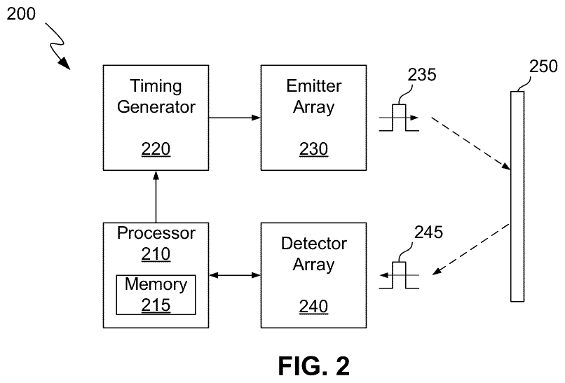

FIG. 2 further illustrates components of a ToF measurement system or circuit 200 in a lidar application in accordance with some embodiments described herein. The circuit 200 can include a processor circuit 210 (for example a digital-signal processor (DSP)), a timing generator 220 that controls timing of the illumination source (illustrated by way of example with reference to a laser emitter array 230), and an array of sensors (illustrated by way of example with reference to a sensor array 240). The processor circuit 210 can also include a sequencer circuit (not shown in FIG. 2) that is configured to coordinate operation of emitter units within the illumination source (emitter array 230) and sensors within the sensor array 240.

The processor circuit 210 and the timing generator 220 can implement some of the operations of the control circuit 110 and the driver circuitry 125 of FIG. 1. Similarly, emitter array 230 and sensor array 240 can be representative of emitter array 130 and sensor array 140 in

FIG. 1. The laser emitter array 230 can emit laser pulses 235 at times controlled by the timing generator 220. Light 245 from the laser pulses 235 can be reflected back from a target (illustrated by way of example as object 250) and can be sensed by sensor array 240. The processor circuit 210 implements a pixel processor that can measure or calculate the time of flight of each laser pulse 235 and its reflected light 245 over the journey from emitter array 230 to object 250 and back to the sensor array 240.

The processor circuit 210 can provide analog and/or digital implementations of logic circuits that provide the necessary timing signals (for example quenching and gating or strobe signals) to control operation of the single-photon detectors of the sensor array 240 and that process the detection signals output therefrom. For example, individual single-photon detectors of sensor array 240 can be operated such that they generate detection signals in response to incident photons only during the gating intervals or strobe windows that are defined by the strobe signals, while photons that are incident outside the strobe windows have no effect on the outputs of the single-photon detectors. More generally, the processor circuit 210 can include one or more circuits that are configured to generate detector or sensor control signals that control the timing and/or durations of activation of the sensors 142 (or particular single-photon detectors therein), and/or to generate respective emitter control signals that control the output of light from the emitter units 132.

Detection events can be identified by the processor circuit 210 based on one or more photon counts indicated by the detection signals output from the sensor array 240, which can be stored in a non-transitory memory 215. In some embodiments, the processor circuit 210 can include a correlation circuit or correlator that identifies detection events based on photon counts (referred to herein as correlated photon counts) from two or more single-photon detectors within a predefined window (time bin) of time relative to one another, referred to herein as a correlation window or correlation time, where the detection signals indicate arrival times of incident photons within the correlation window. Since photons corresponding to the optical signals output from the emitter array 230 (also referred to as signal photons) can arrive relatively close in time with each other, as compared to photons corresponding to ambient light (also referred to as background photons), the correlator can be configured to distinguish signal photons based on respective times of arrival being within the correlation time relative to one another. Such correlators and strobe windows are described, for example, in U.S. Patent Application Publication No. 2019/0250257, entitled “Methods and Systems for High-Resolution Long Range Flash Lidar,” which is incorporated by reference herein in its entirety for all purposes.

The processor circuit 210 can be small enough to allow for three-dimensionally stacked implementations, e.g., with the sensor array 240 “stacked” on top of processor circuit 210 (and other related circuits) that is sized to fit within an area or footprint of the sensor array 240. For example, some embodiments can implement the sensor array 240 on a first substrate, and transistor arrays of the processor circuit 210 on a second substrate, with the first and second substrates/wafers bonded in a stacked arrangement, as described for example in U.S. Patent Application Publication No. 2020/0135776, entitled “High Quantum Efficiency Geiger-Mode Avalanche Diodes Including High Sensitivity Photon Mixing Structures and Arrays Thereof,” the disclosure of which is incorporated by reference herein in its entirety for all purposes.

The pixel processor implemented by the processor circuit 210 can be configured to calculate an estimate of the average ToF aggregated over hundreds or thousands of laser pulses 235 and photon returns in reflected light 245. The processor circuit 210 can be configured to count incident photons in the reflected light 245 to identify detection events (e.g., based on one or more SPADs within the sensor array 240 that have been “triggered”) over a laser cycle (or portion thereof).

The timings and durations of the detection windows can be controlled by a strobe signal (Strobe#i or Strobe<i>). Many repetitions of Strobe#i can be aggregated (e.g., in the pixel) to define a subframe for Strobe#i, with subframes i=1 to n defining an image frame. Each subframe for Strobe#i can correspond to a respective distance sub-range of the overall imaging distance range. In a single-strobe system, a subframe for Strobe #1 can correspond to the overall imaging distance range and is the same as an image frame since there is a single strobe. The time between emitter unit pulses (which defines a laser cycle, or more generally emitter pulse frequency) can be selected to define or can otherwise correspond to the desired overall imaging distance range for the ToF measurement circuit 200. Accordingly, some embodiments described herein can utilize range strobing to activate and deactivate sensors for durations or “detection windows” of time over the laser cycle, at variable delays with respect to the firing of the laser, thus capturing reflected correlated signal photons corresponding to specific distance sub-ranges at each window/frame, e.g., to limit the number of ambient photons acquired in each laser cycle.

The strobing can turn off and on individual photodetectors or groups of photodetectors (e.g., for a pixel), e.g., to save energy during time intervals outside the detection window. For instance, a SPAD or other photodetector can be turned off during idle time, for example after an integration burst of time bins and before a next laser cycle. As another example, SPADs can also be turned off while all or part of a histogram is being read out from non-transitory memory 215.

Yet another example is when a counter for a particular time bin reaches the maximum value (also referred to as “bin saturation”) for the allocated bits in the histogram stored in non-transitory memory 215. A control circuit can provide a strobe signal to activate a first subset of the sensors while leaving a second subset of the sensors inactive. In addition or alternatively, circuitry associated with a sensor can also be turned off and on as specified times.

### 2. Detection of Reflected Pulses

The sensors be arranged in a variety of ways for detecting reflected pulses. For example, the sensors can be arranged in an array, and each sensor can include an array of photodetectors (e.g., SPADs). A signal from a photodetector indicates when a photon was detected and potentially how many photons were detected. For example, a SPAD can be a semiconductor photodiode operated with a reverse bias voltage that generates an electric field of a sufficient magnitude that a single charge carrier introduced into the depletion layer of the device can cause a self-sustaining avalanche via impact ionization. The initiating charge carrier can be photo-electrically generated by a single incident photon striking the high field region. The avalanche is quenched by a quench circuit, either actively (e.g., by reducing the bias voltage) or passively (e.g., by using the voltage drop across a serially connected resistor), to allow the device to be “reset” to detect other photons. This single-photon detection mode of operation is often referred to as “Geiger Mode,” and an avalanche can produce a current pulse that results in a photon being counted. Other photodetectors can produce an analog signal (in real time) proportional to the number of photons detected. The signals from individual photodetectors can be combined to provide a signal from the sensor, which can be a digital signal. This signal can be used to generate histograms.

### 2.1. Time-of-Flight Measurements and Detectors

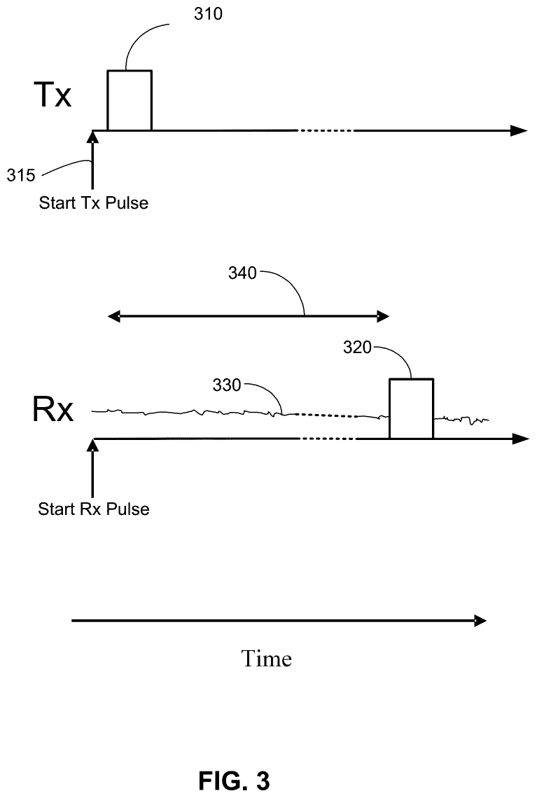

FIG. 3 illustrates the operation of a typical lidar system that can be improved by some embodiments. A laser or other emitter (e.g., within emitter array 230 or emitter array 130) generates a light pulse 310 of short duration. The horizontal axis represents time and the vertical axis represents power. An example laser pulse duration, characterized by the full-width half maximum (FWHM), is a few nanoseconds, with the peak power of a single emitter being around a few watts. Embodiments that use side emitter lasers or fiber lasers can have much higher peak powers, while embodiments with small diameter VCSELs could have peak powers in the tens of milliwatts to hundreds of milliwatts.

A start time 315 for the emission of the pulse does not need to coincide with the leading edge of the pulse. As shown, the leading edge of light pulse 310 can be after the start time 315. One can want the leading edge to differ in situations where different patterns of pulses are transmitted at different times, e.g., for coded pulses. In this example, a single pulse of light is emitted. In some embodiments, a sequence of multiple pulses can be emitted, and the term “pulse train” as used herein refers to either a single pulse or a sequence of pulses.

An optical receiver system (which can include, e.g., sensor array 240 or sensor array 140) can start detecting received light at the same time as the laser is started, i.e., at the start time. In other embodiments, the optical receiver system can start at a later time, which is at a known time after the start time for the pulse. The optical receiver system detects background light 330 initially and after some time detects the laser pulse reflection 320. The optical receiver system can compare the detected light intensity against a threshold to identify the laser pulse reflection 320. Where a sequence of pulses is emitted, the optical receiver system can detect each pulse. The threshold can distinguish the background light 330 from light corresponding to the laser pulse reflection 320.

The time-of-flight 340 is the time difference between the pulse 310 being emitted and the pulse reflection 320 being received. The time difference can be measured by subtracting the emission time of the pulse 310 (e.g., as measured relative to the start time) from a received time of the pulse reflection 320 (e.g., also measured relative to the start time). The distance to the target can be determined as half the product of the time-of-flight and the speed of light. Pulses from the laser device reflect from objects in the scene at different times, depending on start time and distance to the object, and the sensor array detects the pulses of reflected light.

### 2.2. Histogram Signals from Photodetectors

One mode of operation of a lidar system is time-correlated single photon counting (TCSPC), which is based on counting single photons in a periodic signal. This technique works well for low levels of periodic radiation which is suitable in a lidar system. This time correlated counting can be controlled by a periodic signal, e.g., from timing generator 220.

The frequency of the periodic signal can specify a time resolution within which data values of a signal are measured. For example, one measured value can be obtained for each photosensor per cycle of the periodic signal. In some embodiments, the measurement value can be the number of photodetectors that triggered during that cycle. The time period of the periodic signal corresponds to a time bin, with each cycle being a different time bin.

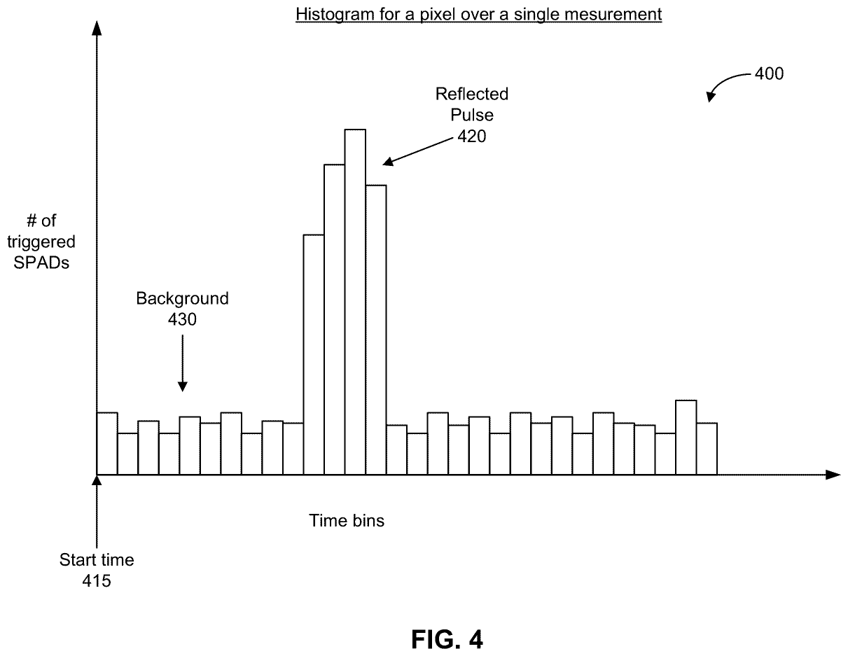

FIG. 4 shows a histogram 400 according to some embodiments described herein. The horizontal axis corresponds to time bins as measured relative to start time 415. As described above, start time 415 can correspond to a start time for an emitted pulse train. Any offsets between rising edges of the first pulse of a pulse train and the start time for either or both of a pulse train and a detection time interval can be accounted for when determining the received time to be used for the time-of-flight measurement. In this example, the sensor pixel includes a number of SPADs, and the vertical axis corresponds to the number of triggered SPADs for each time bin. Other types of photodetectors can also be used. For instance, in embodiments where APDs are used as photodetectors, the vertical axis can correspond to an output of an analog-to-digital converter (ADC) that receives the analog signal from an APD. It is noted that APDs and SPADS can both exhibit saturation effects. Where SPADs are used, a saturation effect can lead to dead time for the pixel (e.g., when all SPADs in the pixel are immediately triggered and no SPADs can respond to later-arriving photons). Where APDs are used, saturation can result in a constant maximum signal rather than the dead-time based effects of SPADs. Some effects can occur for both SPADs and APDs, e.g., pulse smearing of very oblique surfaces can occur for both SPADs and APDs.

The counts of triggered SPADs for each of the time bins correspond to the different bars in histogram 400. The counts at the early time bins are relatively low and correspond to background noise 430. At some point, a reflected pulse 420 is detected. The corresponding counts are much larger and can be above a threshold that discriminates between background and a detected pulse. The reflected pulse 420 results in increased counts in four time bins, which might result from a laser pulse of a similar width, e.g., a 4 ns pulse when time bins are each 1 ns.

The temporal location of the time bins corresponding to reflected pulse 420 can be used to determine the received time, e.g., relative to start time 415. In some embodiments, matched filters can be used to identify a pulse pattern, thereby effectively increasing the signal-to-noise ratio and allowing a more accurate determination of the received time. In some embodiments, the accuracy of determining a received time can be less than the time resolution of a single time bin. For instance, for a time bin of 1 ns, a resolution of one time bin would correspond to a distance about 15 cm. However, it can be desirable to have an accuracy of only a few centimeters.

Accordingly, a detected photon can result in a particular time bin of the histogram being incremented based on its time of arrival relative to a start signal, e.g., as indicated by start time 415. The start signal can be periodic such that multiple pulse trains are sent during a measurement. Each start signal can be synchronized to a laser pulse train, with multiple start signals causing multiple pulse trains to be transmitted over multiple laser cycles (also sometimes referred to as “shots”). Thus, a time bin (e.g., from 200 to 201 ns after the start signal) would occur for each detection interval. The histogram can accumulate the counts, with the count of a particular time bin corresponding to a sum of the measured data values all occurring in that particular time bin across multiple shots. When the detected photons are histogrammed based on such a technique, the result can be a return signal having a signal to noise ratio greater than that from a single pulse train by the square root of the number of shots taken.

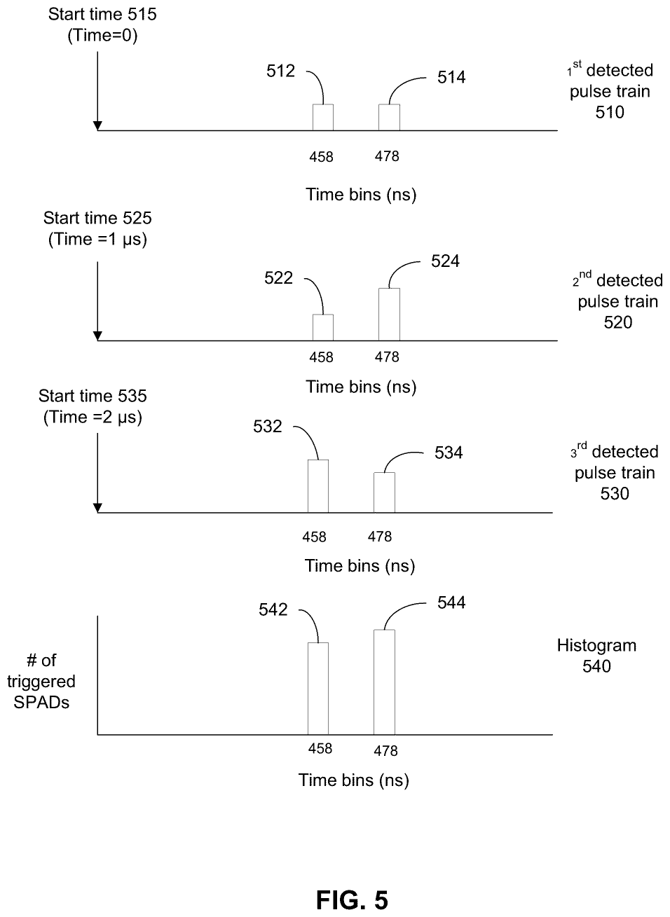

FIG. 5 shows the accumulation of a histogram over multiple pulse trains for a selected pixel according to some embodiments described herein. FIG. 5 shows three detected pulse trains 510, 520 and 530. Each detected pulse train corresponds to a transmitted pulse train that has a same pattern of two pulses separated by a same amount of time. Thus, each detected pulse train has a same pulse pattern, as shown by two time bins having an appreciable value. Counts for other time bins are not shown for simplicity of illustration, although the other time bins can have non-zero values (generally lower than the values in time bins corresponding to detected pulses).

In the first detected pulse train 510, the counts for time bins 512 and 514 are the same. This can result from a same (or approximately the same) number of photodetectors detecting a photon during each of the two time bins, or approximately the same number of photons being detected during the two time bins, depending on the particular photodetectors used. In other embodiments, more than one consecutive time bin can have a non-zero value; but for ease of illustration, individual nonzero time bins have been shown.

Time bins 512 and 514 respectively occur 458 ns and 478 ns after start time 515. The displayed counters for the other detected pulse trains occur at the same time bins relative to their respective start times. In this example, start time 515 is identified as occurring at time 0, but the actual time is arbitrary. The first detection interval for the first detected pulse train can be 1 μs. Thus, the number of time bins measured from start time 515 can be 1,000. After, this first detection interval ends, a new pulse train can be transmitted and detected. The start and end of the different time bins can be controlled by a clock signal, which can be part circuitry that acts as a time-to-digital converter (TDC).

For the second detected pulse train 520, the start time 525 is at 1 μs, at which time the second pulse train can be emitted. Time between start time 515 and start time 525 can be long enough that any pulses transmitted at the beginning of the first detection interval would have already been detected, and thus not cause confusion with pulses detected in the second detection interval. For example, if there is not extra time between shots, then the circuitry could confuse a retroreflective stop sign at 200 m with a much less reflective object at 50 m (assuming a shot period of about 1 us). The two detection time intervals for pulse trains 510 and 520 can be the same length and have the same relationship to the respective start time. Time bins 522 and 524 occur at the same relative times of 458 ns and 478 ns as time bins 512 and 514. Thus, when the accumulation step occurs, the corresponding counters can be added. For instance, the counter values at time bin 512 and 522 can be accumulated or added together.

For the third detected pulse train 530, the start time 535 is at 2 μs, at which time the third pulse train can be emitted. Time bin 532 and 534 also occur at 458 ns and 478 ns relative to start time 535. The counts for corresponding pulses of different pulse trains can have different values even though the emitted pulses have a same power, e.g., due to the stochastic nature of the scattering process of light pulses off of objects.

Histogram 540 shows an accumulation of the counts from three detected pulse trains 510, 520, 530 at time bins 542 and 544, which also correspond to 458 ns and 478 ns. Histogram 540 can have fewer time bins than were measured during the respective detection intervals, e.g., as a result of dropping time bins in the beginning or the end of the detection interval or time bins having values less than a threshold. In some implementations, about 10-30 time bins can have appreciable values, depending on the pattern for a pulse train.

As examples, the number of pulse trains emitted during a measurement to create a single histogram can be around 1-40 (e.g., 24), but can also be much higher, e.g., 50, 100, 500, or 1000. Once a measurement is completed, the counts for the histogram can be reset, and another set of pulse trains can be emitted to perform a new measurement. In various embodiments and depending on the number of detection intervals in the respective measurement cycles, measurements can be performed, e.g., every 25, 50, 100, or 500 μs. In some embodiments, measurement intervals can overlap, e.g., so that a given histogram corresponds to a particular sliding window of pulse trains. In such an example, memory can be provided for storing multiple histograms, each corresponding to a different time window. Any weights applied to the detected pulses can be the same for each histogram, or such weights could be independently controlled.

### 3. Pixel Operation

In some embodiments of the present invention, detector pixel 600, or more simply pixel 600, can include memory block 610, precharge-read-modify-write (PRMW) logic circuits 630, address generator 620, and timing control circuit 650 (all shown in FIG. 6.) Pixel 600 can include one or more photodetectors, for example the SPAD devices shown below in FIG. 20 and FIG. 21, as well as other circuits or components (not shown.) Pixel 600 can be used as sensor 142 (shown in FIG. 1.)

FIG. 6 illustrates an example of a pixel according to an embodiment of the present invention. Pixel 600 can include an Y×4 W memory block 610. Memory block 610 can include an array of memory cells arranged in Y rows and 4 W columns, where the 4 W columns are arranged as four memory banks 640 or sections, each having W memory cells. As shown in FIG. 6, timing control circuit 650 can receive a pixel clock on line 652. Timing control circuit 650 can provide an address generator clock on line 654 and pre-charge, read, modify, and write signals on lines 656 to PRMW logic circuits 630. Memory block 610 can be addressed using address generator 620 that provides Y row addresses on lines 622. Pixel 600 can include four PRMW logic circuits 630 of W bits each for a total of 4 W bits, corresponding to the number of bitlines 612 or columns in memory block 610. In this configuration, four time bins can be stored in each row of memory block 610. In these and other embodiments of the present invention, Y can have a value of 32, 36, 40, 64, or other value, while W can have a value of 8, 10, 12, 16, or other value. Memory block 610 can be divided into two, three, five, or more than five sections with a corresponding number of PRMW logic circuits 630.

Pixels 600 can histogram events detected from one or more SPAD devices (shown in FIG. 21B) following an emitted pulse from emitter array 230 (shown in FIG. 2.) That is, the number of detected events from one or more SPAD devices can be time-sliced into time bins and accumulated in memory block 610. For example, the number of detected SPAD events from four preceding time bins can be stored in a temporary memory in the PRMW logic circuits 630 or other related circuit. Pixel 600 can perform a series of tasks, wherein during a first clock cycle, the PRMW logic circuits 630, under the control of timing control circuit 650, can perform a precharge task, where bitlines 612 for memory block 610 can be precharged. During a second clock cycle, the memory cells in the addressed row can be read by PRMW logic circuits 630. Bin counts stored in the addressed row can be modified by the PRMW logic circuits 630 by adding values from the temporary memory to the read value. The PRMW logic circuits 630 can then perform a write task to write the modified bin counts back to the memory cells for the four time bins in the addressed row in memory block 610. Further details of pixel 600 are described, for example, in U.S. Patent Application Publication No. 63/216,580, entitled “Highly Parallel Large Memory Histogramming Pixel for Direct Time of Flight Lidar,” the disclosure of which is incorporated by reference herein in its entirety for all purposes.

### 4. Generating Histogram Data Using Subframes

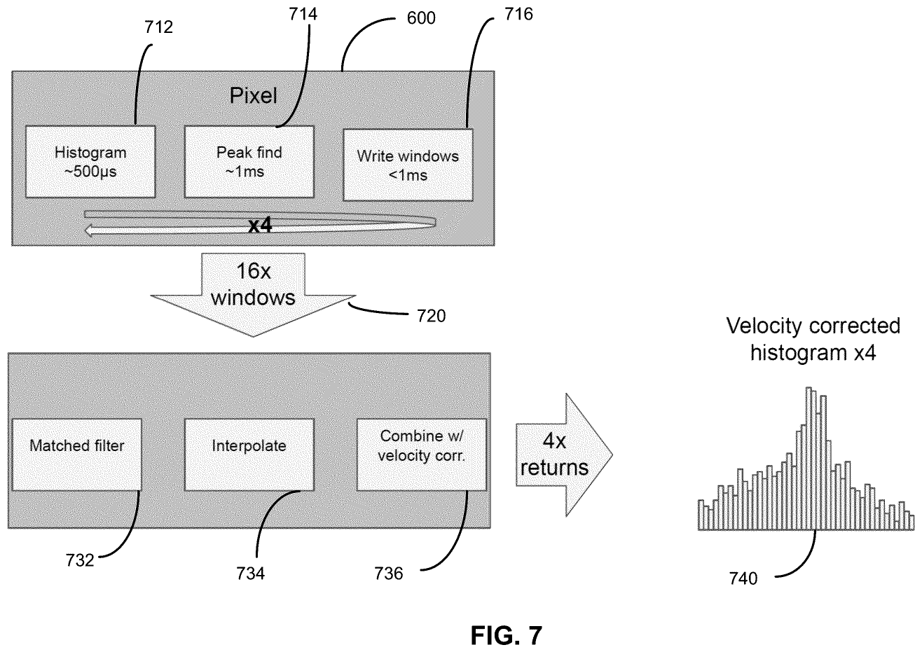

FIG. 7 illustrates a method of generating a histogram in a lidar system according to an embodiment of the present invention. In act 712, a histogram for a first subframe can be generated. The histogram can be stored in memory block 610 in pixel 600 (both shown in FIG. 6.) For example, 250 pulses can be emitted in act 712. Following each pulse, SPAD data can be accumulated or binned. The time for each pulse to travel 200 m and then return is approximately 1.33 μs. This means that sending and receiving SPAD data for 250 pulses, plus some overhead time, can take about 500 μs.

In act 714, one or more peaks in the histogram can be found. For example, one, two, three, four, or more than four peaks can be found. In this specific example, four peaks can be found. This process can consume about 1 ms. In act 716, windows can be generated around these peaks and the windowed peaks can be saved, a process which can consume less than 1 ms. The generating of histograms can be repeated four times in order to generate 16 total windowed peaks in act 720.

In act 732 and 734, the windowed peaks can be filtered and interpolated. These steps can more accurately determine the positions of the peaks in the windowed peaks of act 720. In act 736, a line-fitting or other method can be used to estimate a relative velocity between the lidar system and an object being imaged by pixel 600. That is, a line-fit can be performed on the filtered and interpolated peaks provided by acts 732 and 734 to estimate a relative velocity between the lidar system and an object being imaged by the pixel during the subframes. This estimated velocity can be used to phase shift or align the windows from act 720 to reduce motion blur in resulting histogram 740. This process can be repeated N times, where in this example N is four and four sets of four windows can be generated. The results can be combined in act 736 and provided to image generation circuits.

These various acts can be performed by different circuits in different embodiments of the present invention. For example, the peak detecting and windowing in acts 714 and 716 can be performed in pixel 600 as shown. This can reduce an amount of data that needs to be transferred out of pixel 600, thereby speeding the process of transferring data from pixel 600 and reducing power. Alternatively, these acts can be performed by a digital-signal processor, or other computational circuit separate from pixel 600. The filtering in act 735, the interpolation in act 734, and the velocity correction in act 736 can be performed by the digital-signal processor or other computational circuit, or by a separate circuit, such as a field-programmable gate array or other computational integrated circuit.

In one example, the peak detecting and windowing in acts 714 and 716 can be performed in pixel 600. The windowed peaks can be read out of pixel 600 and provided to a digital-signal processor or other circuit associated with a digital-signal processor. Reading out the windowed peaks, as compared to reading out full histogram data, can reduce an amount of data transferred out of pixel 600 thereby saving time and reducing power dissipation. This can shorten the time to read data out of pixel 600 and can reduce power dissipation. The combined velocity corrected histograms 740 can be provided to an image computational circuit for the generation of an image.

In another example, the SPAD data generated by a pixel can be provided to a digital-signal processor or other computational processor. The peak detecting and windowing in acts 714 and 716 can be performed by the digital-signal processor or other computational processor. Optionally, filtering in act 732 can also be performed by the digital-signal processor or other computational processor. The detected windows can be read out to a separate circuit, such as a field programmable-gate array or other computational integrated circuit. Optionally, filtering in act 732 can also be performed by the field programmable-gate array or other computational integrated circuit. The interpolation in act 734, velocity correction in act 736, and the combining of the resulting histogram 740 can be performed by the field programmable gate array or other computational integrated circuit.

In these and other embodiments of the present invention, other numbers of emitted pulses, other numbers of subframes, and other numbers of windowed peaks can be used. For example, two, three, four, or more than four subframes can be used. For example, eight subframes can be used. One, two, three, four, or more than four windowed peaks can be found for each subframe. Other types of velocity correction can be used. For example, the line-fitting or other interpolation in act 736 can be line-fitting, linear interpolation, nonlinear interpolation, linear regression, other types of regression analysis, or other types of analysis.

Again, subframes can be used to temporally distribute emitted pulses from a laser array in order to distribute power supply noise, reduce heating, and improve performance. An example is shown in the following figure.

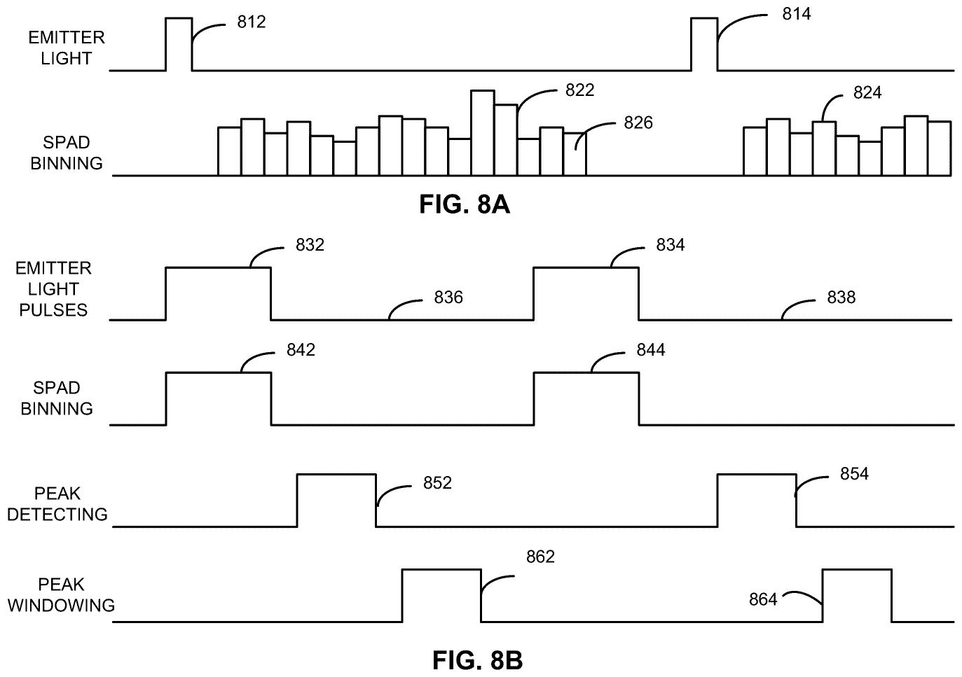

FIG. 8A and FIG. 8B illustrates timing for generating image data according to an embodiment of the present invention. FIG. 8A illustrates timing for a portion of a subframe according to an embodiment of the present invention. The emitter array can generate light pulses 812 and 814. Following each light pulse 812 and 814, data from SPADs can be accumulated into bins 826 in histograms 822 and 824. For example, X/N light pulses 812 and 814 can be generated for each subframe. Following each light pulse 812 and 814, SPADs associated with a pixel can be read over time and the number of diodes that have avalanched can be determined. The number of SPADs that have avalanched at a particular time can be added to a total in a corresponding time bin 826, where the time bins 826 are stored in a histogram memory in the pixel.

FIG. 8B illustrates timing for two subframes according to an embodiment of the present invention. Groups of emitter light pulses 832 and 834 can be generated by an emitter array. Groups of emitter light pulses 832 and 834 can each include X/N light pulses 812 and 814 as shown in FIG. 8A. In this and other examples, X can be 1000, 1024, or X can have another value, while N can be four, or N can have another value. Following each individual light pulse, counts of avalanched SPADs can be accumulated in histogram memory to form a histogram during periods 842 and 844. Once a histogram is complete following SPAD binning periods 842 and 844, peaks can be detected in the resulting histograms during times 852 and 854. This peak detecting can be done for example by the filtering and interpolation act 732 and act 734 in FIG. 7. Windows can be generated around these peaks during times 862 and 864.

By distributing light pulses and histogramming among more than one group of emitter pulses 832 and 834 and histogram accumulations, power supply spikes and heating can also be distributed. Distributing power supply spikes can reduce the load on power supply capacitors, power transistors, and other components. Reducing heating can improve performance and increase durability of the lidar system.

Various numbers of groups of emitter light pulses can be used in these and other embodiments of the present invention. For example, two, four, eight, or other numbers of groups of emitter light pulses can be used. Other numbers such as three, five, or more than five groups of emitter light pulses can be used. Also various numbers of peaks can be detected for each subframe. For example, one, two, three, four, or more than four peaks can be detected for each histogram following each subframe.

### 5. Phase Shifting Subframes

In these and other embodiments of the present invention, the binning for each of the subframes can be phase shifted relative to each other. For example, the clock signal generated by timing control circuit 650 and used to clock the memory block 610 in pixel 600 (all shown in FIG. 6) can be phase shifted for each subframe. In general, this phase shift can be 360 degrees divided by the number of subframe is used. For example, when two subframes are used, the phase shift can be 180 degrees, or π radians. When four subframes are used, the phase shift can be 90 degrees, or π/2 radians. This phase shifting can provide various benefits. For example, where N subframes are used, the timing resolution can be increased by a factor of N. Alternatively, where N subframes are used, the amount of data stored in memory can be reduced by approximately a factor of N. Alternatively, the timing resolution can be increased and the amount of data to be stored can be decreased. For example, where four subframes are used, the timing resolution can be increased by a factor of two and the amount of data stored in memory can be reduced by a factor of approximately two as well. For example, the duration of each bin can be increased by a factor of two, or the distance covered by a histogram can be reduced by a factor of two by reducing the number of bins used by 2. An example of this phase shifting is shown in the following figure.

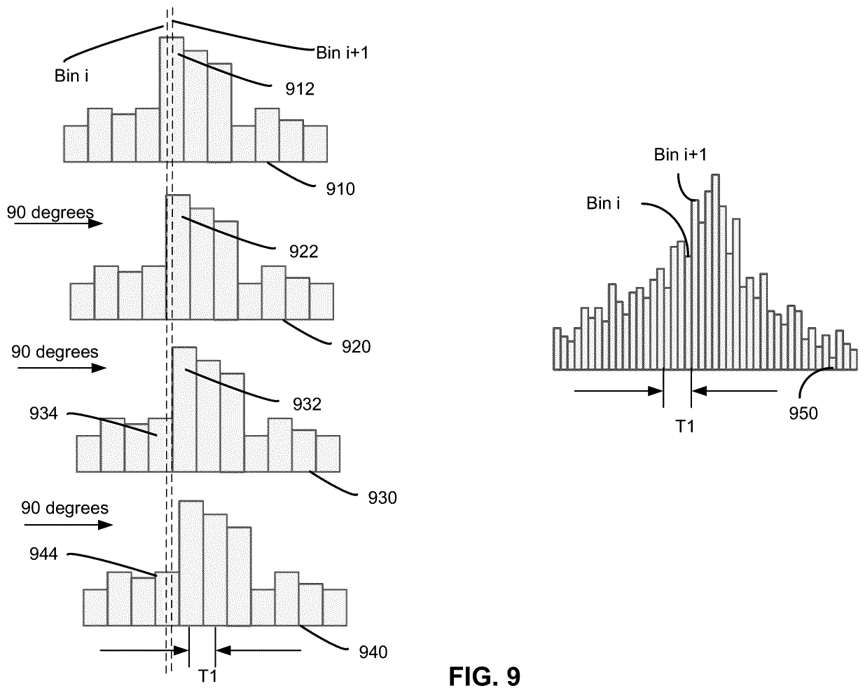

FIG. 9 illustrates a method of phase shifting subframes according to an embodiment of the present invention. In this example, four subframes are used for each frame. Histograms from the subframes can be peak detected and windowed to generate windowed peak data. More specifically, an initial histogram can be binned into memory block 610 in pixel 600. This initial histogram can be stored in memory block 610 while being clock by a nominal memory clock signal. The initial histogram can be peak detected and windowed to generate binned data 910, which can then be transferred to a second memory. The memory clock signal can be phase shifted 90 degrees as shown and a second histogram can be binned into memory block 610 in pixel 600. The second histogram can be peak detected and windowed to generate bin data 920, which can be transferred to the second memory. The memory clock can again be phase shifted by 90 degrees For a total of 180 degrees, and a third histogram can be binned into memory in pixel 600. This third histogram can be peak detected and windowed to generate binned data 930, which can be transferred to the second memory. The memory clock can again be phase shifted by 90 degrees For a total of 270 degrees, and a fourth histogram can be binned into memory in pixel 600. This fourth histogram can be peak detected and windowed to generate binned data 940, which can be transferred to the second memory. For each binned data 910, 920, 930, and 940, the histogram can be transferred to a third memory, before being peak detected and windowed and transferred to the second memory.

The four windowed peaks represented by binned data 910, 920, 930, and 940, can be combined and used in forming a lidar image. Since a new bin begins every 90 degrees For one of the four binned data 910, 920, 930, and 940, the resulting combined data 950 has a timing resolution that is four times that of the four binned data 910, 920, 930, and 940. That is, while each bin of each binned data 910, 920, 930, and 940, has a duration of T1, four bins of combined data 950 also has a duration of T1 as shown.

As an example, combined Bin i can be the sum of bins 912, 922, 934, and 944, while combined Bin i+1 can be the sum of bins 912, 922, 932, and 944. That is, with the 90 degree phase shift, the combined Bin i can include 934 while Bin i+1 can include the higher value in bin 932. The totals in combined Bin i and combined Bin i+1 can be divided by 4 or normalized in some other manner.

In these and other embodiments of the present invention, the timing resolution can be increased by a factor that is equal to the number of subframes used. As shown in this example, four subframes are used and the timing resolution of resulting combined data 950 is increased by a factor of four. Alternatively, the bin durations of each of the bins of binned data 910, 920, 930, and 940 can be increased. For example, their durations can be increased by a factor of four, meaning that the resulting combined data 950 would have the original timing resolution. This could mean a decrease in the amount of memory needed to store binned data 910, 920, 930, and 940. Alternatively, a combination of increased timing resolution and decreased memory can be achieved. For example, the duration T1 of the bins of binned data 910, 920, 930, and 940 can be doubled, which would result in a doubling of the timing resolution of combined data 950 and decrease the amount of memory needed. Also, in these and other embodiments of the present invention, the bit depth of the histogrammed data can be reduced. In one example, the bit depth of histogrammed data can be reduced from 14 bits to 10 bits.

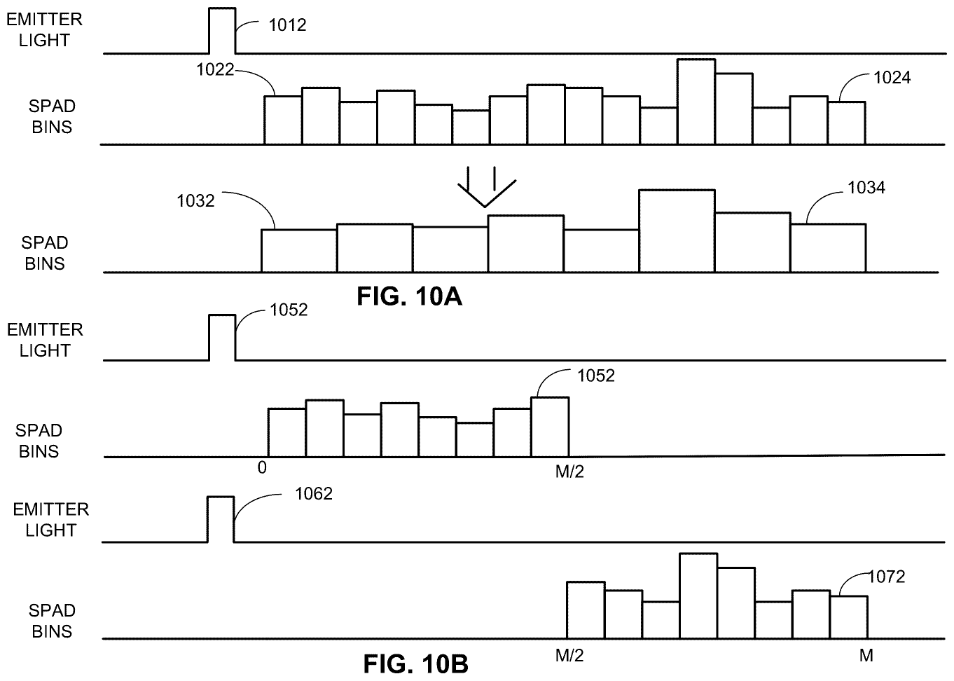

FIG. 10A and FIG. 10B illustrate improvements that can be gained by phase shifting subframes according to an embodiment of the present invention. In FIG. 10A, SPAD data 1022 can be stored in bins 1024 following in the emitted light pulse 1012. Where subframes and phase shifting are employed, the resulting timing resolution can be increased by a factor of N, where N is equal to the number of subframes used. In this example, two subframes can be used. This allows the size of bins 1034 used to store SPAD data 1032 to be doubled in duration while maintaining the same timing resolution. This can reduce an amount of memory needed to store SPAD data 1032. Alternatively, in this example, four subframes can be used. This can still allow the size of bins 1034 to be doubled in duration, while also providing a doubling in timing resolution. In this way, N subframes each having longer been durations can be employed.

In FIG. 10 B, data can be captured over a portion of a range during each subframe. For example, following an emitted pulse 1052, SPAD data can be binned over half of the range, from zero to M/2, where M is a range being used by the lidar system. Following emitted pulse 1062, SPAD data can be binned over the other half of the range, from M/2 to M. in this way, subframes can gather data at various timing resolutions or various distances, and the subframes can be combined to form an image. M can have different values in these and other embodiments of the present invention. M can have a value of 200 m, 300 m, 400 m, 500 m, 600 m, or other distances. Also, in these and other embodiments of the present invention, the bit depth of the histogrammed data can be reduced. In one example, the bit depth of histogrammed data can be reduced from 14 bits to 10 bits.

Phase shifting the binning of SPAD data among subframes can provide various other benefits. For example, where a peak is near an edge of a bin, phase shifting the histogram accumulations among subframes can more accurately pinpoint its location. An example is shown in the following figure.

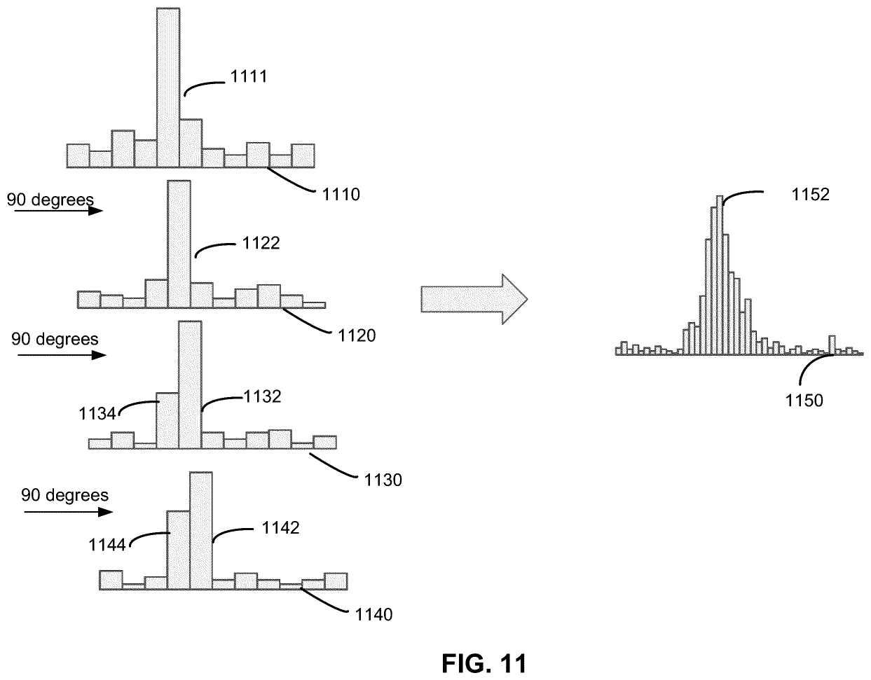

FIG. 11 illustrates phase shifting subframes according to an embodiment of the present invention. In this example, an initial histogram can be peak detected to find a peak in bin 1111 and windowed to generate binned data 1110. This peak is located in bin 1111, but without more it cannot be determined where in bin 1111 the peak is located. Accordingly, subsequent histograms can be generated, and their data can be peak detected and windowed to generate binned data 1120, 1130, and 1140. As shown in this example, in binned data 1130, the peak is somewhat distributed between bins 1132 and 1134. Similarly, in binned data 1140, the peak is more equally distributed between bins 1142 and 1144. This can tend to indicate that the peak is closer to the leftmost (as drawn) edge of bin 1111 in binned data 1110. Combining binned data 1110, 1120, 1130, and 1140 into combined data 1150 improves the timing resolution of the position of the peak located in bin 1152 by a factor of four.

### 6. Increasing Dynamic Range by Changing Emitter Power Among Subframes

These and other embodiments of the present invention can increase the dynamic range of a lidar system. For example, the emitters can emit light pulses at a first power level for one or more initial subframes. The emitters can then emit light pulses at a second power level for one or more subsequent subframes, where the second power level is at a lower or higher power level than the first power level. As an example, where one or more bins in the initial subframes are at a saturation level, the emitter power can be reduced for one or more subsequent frames. An example is shown in the following figure.

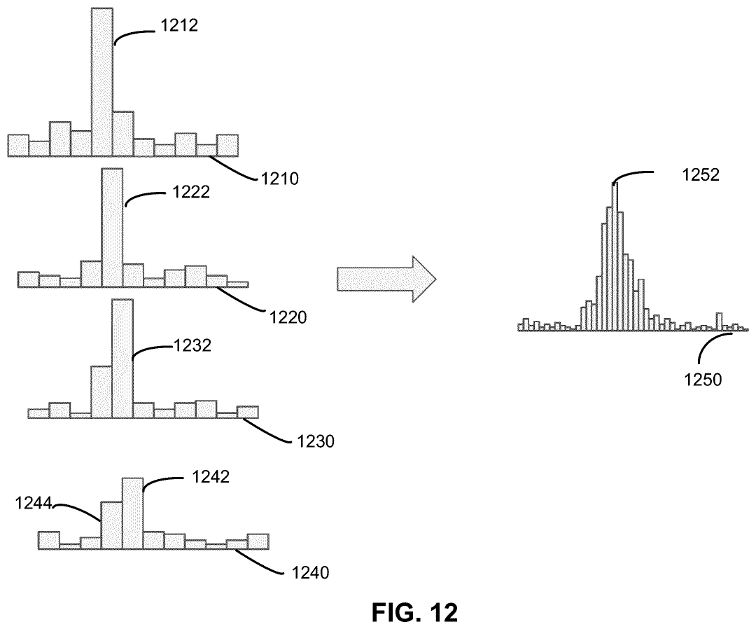

FIG. 12 illustrates a method of improving the dynamic range of a lidar system according to an embodiment of the present invention. In this example, an initial histogram can be peak detected to find a peak located in bin 1210 and windowed to generate data bin 1212. In this example, bin 1212 can be saturated, for example by a high-flux object. Similarly, a second phase shifted histogram can be generated, peak detected to find the peak in bin 1222, and windowed to generate binned data 1220. As with bin 1212, bin 1222 can be saturated due to the high-flux object. A third phase shifted histogram can be generated, peak detected to find a peak in bin 1232, and then windowed to generate binned data 1230. As with bins 1212 and 1222, bin 1232 can be at or near saturation. To avoid saturation during the generation of a fourth histogram, the emitter power can be reduced. The reduced emitter power can result in a fourth phase shifted histogram, which can then be peak detected to find a peak in bin 1242 and can be windowed to generate binned data 1240. In this example, bin 1242 is not saturated and its relative amplitude, for example as compared to bin 1244, can be more accurate. This can help to accurately position the peak in bin 1252 in combined data 1250.

In another example, the received SPAD data can be at a low level and a peak can be difficult to find. In this case, the emitter power can be increased for one or more subframes and the results can be combined.

### 7. Correcting for Motion that Occurs Between Subframes

In these and other embodiments of the present invention, data for each of the subframes can be generated in a temporally displaced manner. That is, there can be a period between the generation of each of the subframes. Either or both the linear system and an object being imaged by the pixel can move during this time. This relative motion can cause smearing in the combined data when windowed peaks are added together. Accordingly, embodiments of the present invention can provide a velocity correction to data from each of the subframes. An example is shown in the following figure.

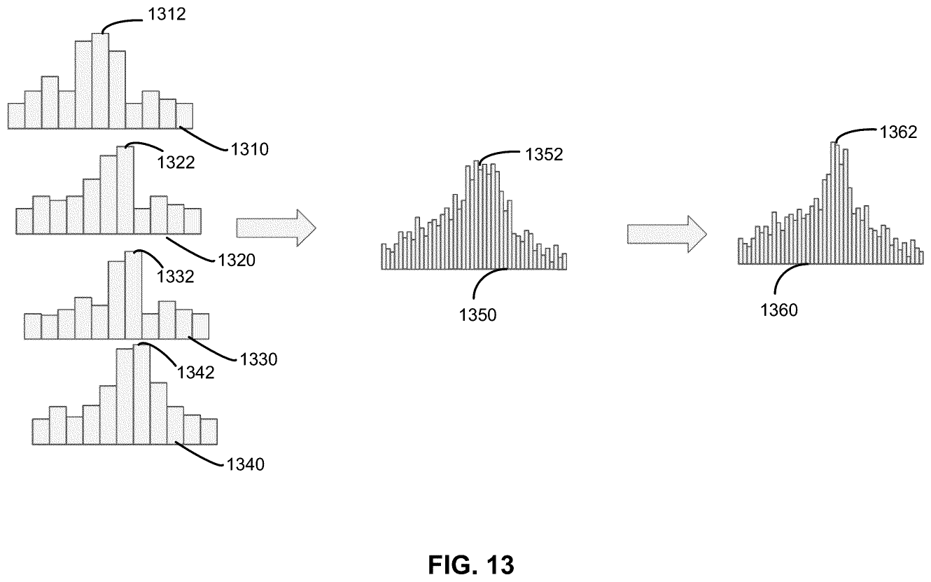

FIG. 13 illustrates a method of compensating for motion during the generation of histogram data according to an embodiment of the present invention. In this example, an initial histogram can be peak detected to find a peak located in bin 1312, and windowed to form binned data 1310. Subsequent phase shifted histograms can be generated, peak detected to find peaks in bins 1322, 1332, and 1342, and windowed to generate binned data 1320, 1330, and 1340. The binned data 1313, 1320, 1330, and 1340, can be combined to form data 1350. When movement occurs during the generation of the initial and subsequent histograms, data 1350 can be spread or smeared, and peak 1352 can be ill-defined, that is, the results can have a low signal-to-noise ratio.

Accordingly, embodiments of the present invention can line-fit or use other interpolation or regression technique to estimate relative movement between the lidar system and an object being imaged during the generation of the four corresponding subframes. More specifically, the filtering and interpolation of acts 732 and 734 (shown in FIG. 7) can be used to determine a peak in each of binned data 1310, 1320, 1330, and 1340. The peaks can then be line-fitted to estimate a motion that occurred during the N subframes. This line-fitting or other interpolation or regression method can be used to compensate for the motion, resulting in combined data 1360. That is, the peaks in each of the binned data 1310, 1320, 1330, and 1340 can be aligned to compensate for movement during the subframes. Peak 1362 can be found to be relatively well-defined as compared to the uncompensated peak 1352 in uncompensated data 1350. That is, the results now have a higher signal-to-noise ratio. The results of the line-fitting or other interpolation can also be provided to other circuits in the lidar system as an indication of the relative motion or radial velocity between the lidar system and the object being imaged by the pixel.

The technique that is performed to estimate relative velocities can be varied. For example, line-fitting, linear interpolation, nonlinear interpolation, or other type of interpolation can be used. A linear or other type of regression analysis can alternatively be used as well.

### 8. Example Methods and Circuit Implementations

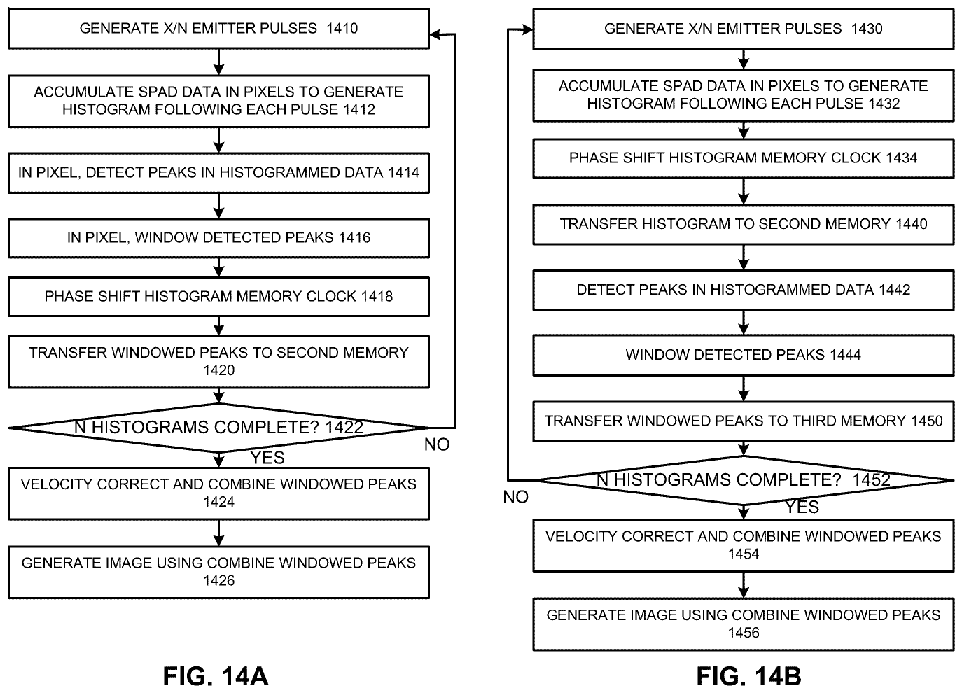

FIG. 14A and FIG. 14B are flowcharts illustrating methods of generating image data according to an embodiment of the present invention. In FIG. 14A, a number of pulses can be emitted in act 1410. Following each pulse, SPAD data can be accumulated in a histogram in act 1412. This SPAD data can be accumulated in a histogram memory in a pixel 600 (shown in FIG. 6.) In the pixel, peaks can be detected in the histogram to data in act 1414. In act 1416, these peaks can be windowed. The histogram memory clock can be phase shifted for the next histogram in act 14 18. The windowed peaks can be transferred to a second memory in act 1420. The second memory can be located externally from the pixel. For example, the second memory can be part of or associated with a digital signal processor, field programmable gate array, or other circuit.

In act 1422, it can be determined whether all N histograms have been completed. If they have not, the next subframe can begin in act 1410. If all N subframe histograms have been completed, velocity correction can be applied and the windowed peaks can be combined in act 1424. An image can be generated using the combined windowed peaks and act 1426.

In FIG. 14B, a number of pulses can be emitted in act 1430. Following each pulse, SPAD data can be accumulated in a histogram in act 1432. The SPAD data can be accumulated in a histogram memory in pixel 600. The histogram memory clock can be phase shifted in act 1434 in anticipation of the next subframe. The histogram data can be transferred to a second memory in act 1440. The second memory can be a memory that is part of or associated with a digital-signal processor or other circuit.

Peaks can be detected in the histogram data in act 1442, and the peaks can be windowed in act 1444. In act 1450, the windowed peaks can be transferred to a third memory. The third memory can be part of or associated with an external field-programmable gate array or other circuit. In act 1452, it can be determined whether all N histograms have been completed. If they have not, the next subframe can begin in act 1430. If they have, the data can be velocity corrected and combined in act 1454. An image can be generated using the combined windowed peaks in act 1456.

In the examples above, peak power dissipation in a lidar system is spread over an increased range of time. Spreading emitter power over time can provide several advantages. Dispersing the power supply noise and current spikes can reduce the load or stress on power supply components such as power transistors, decoupling capacitors, and others. Power supply noise and voltage drops can be reduced by allowing power supply decoupling capacitors time to recover between bursts of pulses. This can allow the use of lower-power transistors, smaller capacitors, and other changes that can conserve resources. Component heating, for example in the emitter array, can be reduced by providing time between bursts of pulses for device cooling. Lidar system performance can be improved since power supplies, bias lines, device temperatures, and other parameters have time to recover between the multiple smaller bursts of pulses, or subframes, as compared to a longer, single burst of pulses.

The examples above utilize multiple subframes instead of a single frame. Using multiple subframes instead of a single frame can provide various advantages. Multiple subframes can disperse power supply noise and glitching over a longer period as compared to sending emitted pulses and accumulating SPAD data as a single frame. Also, since histogram data can be moved out of the pixel circuits for each subframe, a reduced amount of memory can be needed in each pixel, thereby simplifying pixel circuitry. Further, by phase shifting subframe histogram data before combining, timing resolution of the combined histogram data can be increased by a factor of N. The linear regression, linear interpolation, or other method used to align the subframe data can provide a relative radial velocity between the lidar system and an object being imaged by the pixel.

The use of subframes can help to reduce the amount of memory needed to generate windowed peak histogram data. For example, since data can be moved out of pixel memory after each subframe, a reduced amount of pixel memory can be needed. Since timing resolution is gained by phase shifting subframes, the timing resolution of data collected can be reduced, that is, bin width can be increased. Also or instead, histogram length can be reduced to further save memory. The windowing around each peak can be made to be more conservative or aggressive. For example, a window size can be one, two, or three bins larger for conservative windowing. The digital-signal processing circuits needed to find peaks and windows can be included in each pixel, or they can be included outside of the pixel in the lidar system. In one embodiment, the bit depth can be decreased from 14 bits to 10 bits using the methods described herein. This can reduce the memory needed by 30 percent. Also, as described above, the size of a bin can be increased, or the number of bins can be reduced for a shorter range, as described above. This can further reduce the amount of memory needed by 50 percent.

### 9. Multiple Lidar Units

Depending on their intended purpose or application, lidar sensors can be designed to meet different field of view (FOV) and different range requirements. For example, an automobile (e.g., a passenger car) outfitted with lidar for autonomous driving might be outfitted with multiple separate lidar sensors including a forward-facing long range lidar sensor, a rear-facing short-range lidar sensor and one or more short-range lidar sensors along each side of the car.

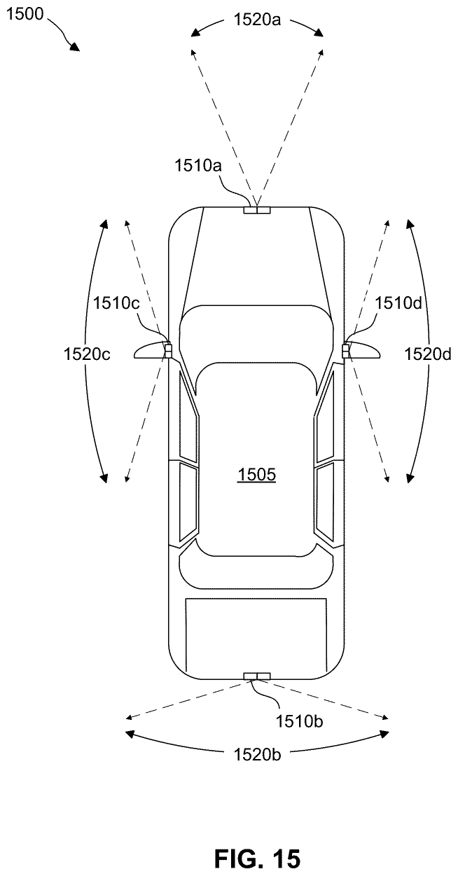

FIG. 15 is a simplified illustration of an automobile 1500 in which four solid-state flash lidar sensors 1513a-1513d are included at different locations along the automobile. The number of lidar sensors, the placement of the lidar sensors, and the fields of view of each individual lidar sensors can be chosen to obtain a majority of, if not the entirety of, a 360-degree Field of view of the environment surrounding the vehicle some portions of which can be optimized for different ranges. For example, lidar sensor 1513a, which is shown in FIG. 15 as being positioned along the front bumper of automobile 1500, can be a long-range (200 meter), narrow field-of-view unit, while lidar sensors 1513b, positioned along the rear bumper, and lidar systems 1513c, 1513d, positioned at the side mirrors, are short-range (50 meter), wide field-of-view systems.

Despite being designed for different ranges and different fields of view, each of the lidar sensors 1513a-1513d can be a lidar system according to embodiments disclosed herein. Indeed, in some embodiments, the only difference between each of the lidar sensors 1513a-1513d is the properties of the diffuser (e.g., diffuser 136). For example, in long range, narrow field-of-view lidar sensor 1513a, the diffuser 136 is engineered to concentrate the light emitted by the emitter array of the lidar system over a relatively narrow range enabling the long-distance operation of the sensor. In the short-range, wide field-of-view lidar sensor 1513b, the diffuser 136 can be engineered to spread the light emitted by the emitter array over a wide angle (e.g., 180 degrees). In each of the lidar sensors 1513a and 1513b, the same emitter array, the same pixel array and the same controller, etc. can be used thus simplifying the manufacture of multiple different lidar sensors tailored for different purposes. Any or all of lidar sensors 1513a-1513dcan incorporate the circuits, methods, and apparatus that can provide sensor arrays that are able to avoid or limit saturation of SPAD devices from both ambient and reflected light while maintaining sufficient sensitivity for generating a lidar image as described herein.

### 10. Additional Embodiments

In the above detailed description, numerous specific details are set forth to provide a thorough understanding of embodiments of the present disclosure. However, it will be understood by those skilled in the art that the present disclosure can be practiced without these specific details. For example, while various embodiments set forth above described can use different numbers of subframes and different power levels, these and other embodiments can use still other numbers of subframes and different power levels. Also, ranges for which SPAD data is binned can be varied. As another example, some of the embodiments discussed above include types of interpolation and other velocity estimates. It is to be understood that those embodiments are for illustrative purposes only and embodiments are not limited to any particular type of velocity estimation.

One or more other techniques can be incorporated into embodiments of the present invention. For example, emitter firing delays in one or more subframes can be dithered to improve resolution.

Computer programs incorporating features of the present invention that can be implemented using program code may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may include an internal storage medium of a compatible electronic device and/or external storage media readable by the electronic device that can execute the code. In some instances, program code can be supplied to the electronic device via Internet download or other transmission paths.

It should be understood that a computer system or electronic device can include hardware components of generally conventional design (e.g., processors, memory and/or other storage devices, user interface components, network interface components) and that program code or other instructions can be provided to the computer system or electronic device to cause the system to perform computations and/or other processes implementing embodiments described herein or aspects thereof.

Additionally, in some instances, well-known methods, procedures, components, and circuits have not been described in detail so as not to obscure the present disclosure. It is intended that all embodiments disclosed herein can be implemented separately or combined in any way and/or combination. Aspects described with respect to one embodiment can be incorporated in different embodiments although not specifically described relative thereto. That is, all embodiments and/or features of any embodiments can be combined in any way and/or combination.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A system of generating histogram data, the system comprising circuitry to:
emit a first series of light pulses, and for each light pulse, receive first data from a plurality of SPADs;
for the first series of light pulses, bin the received first SPAD data in a histogram memory;
transfer at least a portion of the binned first SPAD data to a second memory;
emit a second series of light pulses, and for each light pulse, receive second data from the plurality of SPADs;
for the second series of light pulses, bin the received second SPAD data in the histogram memory;
transfer at least a portion of the binned second SPAD data to the second memory;
combine the transferred binned first SPAD data and the transferred binned second SPAD data; and
generate an image using the combined SPAD data.

2. The system of claim 1 wherein binning the received second SPAD data in the histogram memory following the second series of light pulses comprises phase shifting the binning of the received second SPAD data into the histogram memory.

3. The system of claim 2 wherein phase shifting the binning of the received second SPAD data is done by phase shifting a clock for the histogram memory by 90 degrees.

4. The system of claim 2 wherein transferring at least a portion of the binned first SPAD data to the second memory comprises detecting a first peak in the binned first SPAD data, windowing the detected first peak, and transferring the windowed first peak to the second memory, and
wherein transferring at least a portion of the binned second SPAD data to the second memory comprises detecting a second peak in the accumulated second SPAD data, windowing the detected second peak, and transferring the windowed second peak to the second memory.

5. The system of claim 4 wherein combining the transferred binned first SPAD data and the transferred binned second SPAD data further comprises aligning the windowed first peak with the windowed second peak.

6. The system of claim 5 wherein windowed first peak is aligned with the windowed second peak using line-fitting.

7. The system of claim 5 wherein windowed first peak is aligned with the windowed second peak using linear interpolation.

8. The system of claim 5 wherein the first series of light pulses are emitted at a first power and the second series of light pulses are emitted at a second power, the first power different than the second power.

9. The system of claim 5 further comprising:
before transferring at least a portion of the binned first SPAD data to the second memory, transferring the binned first SPAD data to a third memory, and before transferring at least a portion of the binned second SPAD data to the second memory, transferring the binned second SPAD data to the third memory.

10. The system of claim 9 wherein the second memory is on a field-programmable gate array and the third memory is a memory coupled to a digital-signal processor.

11. A system of generating histogram data, the system comprising circuitry to:
emit a first series of light pulses, and for each light pulse, receive data from a plurality of SPADs;
for the first series of light pulses, bin the received SPAD data in a histogram memory;
detect a first peak in the accumulated SPAD data;
window the detected first peak;
transfer the windowed first peak to a second memory;
emit a second series of light pulses, and for each light pulse, receive data from the plurality of SPADs;
for the second series of light pulses, bin the received SPAD data in the histogram memory;
detect a second peak in the binned SPAD data;
window the detected second peak;
transfer the windowed second peak to the second memory;
combine the windowed first peak with the windowed second peak; and
generate an image using the combined windowed first peak and the windowed second peak.

12. The system of claim 11 wherein binning the received SPAD data in the histogram memory following the second series of light pulses comprises phase shifting the binning of the received data into the histogram memory.

13. The system of claim 12 wherein phase shifting the binning of the received SPAD data is done by phase shifting a clock for the histogram memory by 90 degrees.

14. The system of claim 13 wherein combining the windowed first peak with the windowed second peak comprises utilizing line-fitting.

15. The system of claim 14 wherein the first series of light pulses are emitted at a first power and the second series of light pulses are emitted at a second power, the first power different than the second power.

16. A system for generating histogram data, the system comprising circuitry to:
emit a first series of light pulses, and for each light pulse, receive data from a plurality of SPADs;
for the first series of light pulses, bin the received SPAD data in a histogram memory;
transfer the binned SPAD data to a second memory;
detect a first peak in the transferred SPAD data;
window the detected first peak and storing the windowed first peak;
emit a second series of light pulses, and for each light pulse, receive data from the plurality of SPADs;
for the second series of light pulses, bin the received SPAD data in the histogram memory;
transfer the binned SPAD data to the second memory;
detect a second peak in the transferred SPAD data;
window the detected second peak and storing the windowed second peak;
combine the windowed first peak with the windowed second peak; and
generate an image using the combined windowed first peak and the windowed second peak.

17. The system of claim 16 wherein binning the received SPAD data in the histogram memory following the second series of light pulses comprises phase shifting the binning of the received SPAD data into the histogram memory.

18. The system of claim 17 wherein phase shifting the binning of the received SPAD data is done by phase shifting a clock for the histogram memory by 90 degrees.

19. The system of claim 18 wherein combining the windowed first peak with the windowed second peak comprises utilizing line-fitting.

20. The system of claim 19 further comprising, before combining the windowed first peak with the windowed second peak, transferring the windowed first peak and the windowed second peak to a third memory.
